(19) United States
(12) Patent Application Publication
(10) Pub. No.: US 2006/0196979 A1
(43) Pub. Date: Sep. 7, 2006

(54) AUDIO OPERATION INDICATOR FOR FOOD WASTE DISPOSER

(75) Inventors: Steven P. Hanson, Racine, WI (US); William F. Strutz, Racine, WI (US); Thomas R. Berger, Racine, WI (US)

Correspondence Address: LOCKE LIDDELL & SAPP LLP;ATTN. DOCKETING, 600 TRAVIS #3400, HOUSTON, TX, 77002, US

(73) Assignee: EMERSON ELECTRIC CO., St. Louis, MO (US)

(21) Appl. No.: 11/306,143

(22) Filed: Dec. 16, 2005

Related U.S. Application Data
(63) Continuation-in-part of application No. 10/458,099, filed on Jun. 10, 2003, now Pat. No. 7,066,415.

(51) Int. Cl. B02C 19/00

(52) U.S. Cl. 241/30; 241/101.3

(57) ABSTRACT

A food waste disposer system includes a food waste disposer and an audio indicator operably connected to the food waste disposer. The audio indicator outputs a predetermined sound, such as a voice message or music, in response to activating the disposer.

### CROSS-REFERENCE TO RELATED APPLICATIONS

This application is a continuation-in-part of co-pending U.S. patent application Ser. No. 10/458,099, filed on Jun. 10, 2003, which is incorporated by reference in its entirety.

### BACKGROUND

The present invention relates generally to food waste disposers.

Food waste disposers are used to comminute food scraps into particles small enough to safely pass through household drain plumbing. A conventional disposer includes a food conveying section, a motor section, and a grinding mechanism disposed between the food conveying section and the motor section. The food conveying section includes a housing that forms an inlet connected to a sink flange for receiving food waste and water. The food conveying section conveys the food waste to the grinding mechanism, and the motor section includes a motor imparting rotational movement to a motor shaft to operate the grinding mechanism.

Conventional food waste disposers produce noise during operation. This is due, in part, by the operation of the motor as well as by the food impacting against the disposer body and grind components. Thus, the fact that an older disposer is “on” or running is obvious to a person in the vicinity of the disposer. However, several means have been developed and employed to reduce disposer noise. For example, sound insulating materials have been placed around the exterior housing of the disposer to reduce noise. A baffle may be provided between the disposer inlet and the drain opening, which keeps food waste from getting “kicked back” up through the drain opening when the disposer is operating and additionally prevents some of the noise from the disposer from traveling up through the sink to be heard by users. Still further, anti-vibration mounting systems have been used to reduce noise generated by the disposer motor vibrations and vibrations resulting from food impacting the inside of the disposer.

Improved operating modes for disposers have further reduced noise. Common food waste disposers are typically single speed devices usually operated by a switch that is often mounted to a wall in near vicinity to the disposer (e.g., beside the sink to which the disposer is affixed). This may not be most advantageous, because a single grinding speed is not always optimal for grinding foods of different hardnesses or constituencies, and otherwise limits the functionality of the disposer. For example, U.S. Pat. No. 6,481,652, which is incorporated herein by reference in its entirety, discloses a food waste disposer which can operate at various speeds to either optimize grinding or perform other beneficial functions. The '652 patent discloses an algorithm in which an idle mode detects whether food waste is present in the disposer, and drops the disposer's speed during periods when the food waste disposer is empty (such as when the user is walking back and forth between the dinner table and the disposer) to decrease the noise of the disposer.

As noted above, the noise generated by older disposers makes it easy to discern whether a disposer is operating. A newer disposer, however, can be so quiet when operating that it is difficult to tell whether it is on. Conventional disposers provide the user with no indication of the disposer's operational status.

The present application addresses shortcomings associated with the prior art.

### SUMMARY

Some food waste disposer systems are so quiet when they are operating, a person in the vicinity of the disposer can forget it is on. Accordingly, a food waste disposer system is disclosed that includes a food waste disposer and an audio indicator operably connected to the food waste disposer. The audio indicator outputs a predetermined sound, such as a voice message or music, in response to activating the disposer.

In accordance with aspects of the present disclosure, the audio indicator includes an audio circuit and a speaker. The audio indicator is situated within an enclosure housing the food waste disposer in some embodiments, and in other embodiments it is situated within an enclosure positioned remotely from the food waste disposer. The enclosure may include an electrical outlet for receiving an electrical plug of the food waste disposer, and may further include an electrical plug that is receivable by a household electrical outlet.

### BRIEF DESCRIPTION OF THE DRAWINGS

Other objects and advantages of the invention will become apparent upon reading the following detailed description and upon reference to the drawings in which:

FIG. 1 illustrates a food waste disposer system having a disposer mounted under a sink and coupled to a control information system.

FIG. 2 illustrates the control information system in further detail.

FIGS. 3 and 4 illustrate embodiments of disposer systems having audio indicators.

FIG. 5 illustrates a food waste disposer system having a disposer mounted under a sink and coupled to an audio indicator.

FIGS. 6 and 7 are perspective views of an audio indicator housed in an enclosure.

FIG. 8 is a schematic diagram of an audio indicator system.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

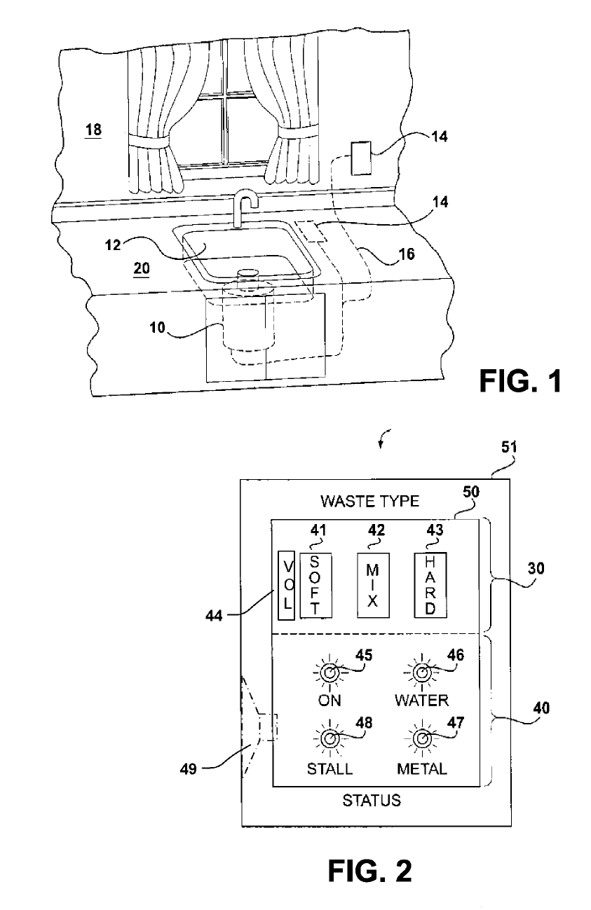

FIG. 1 shows a disposer 10 mounted under a sink 12, and in electrical communication with a control information system 14. The control information system 14 preferably communicates with the disposer 10 through the use of a conduit or bus 16, which contains the wires that span between the disposer and the touch pad in accordance with a circuit schematic to be explained later. However, and as explained later, the control information system 14 and disposer can also communicate by a wireless link. The touch pad is illustrated as mounted to a wall 18, but could also be attached to an adjacent countertop 20 as shown in dotted lines. As one skilled in the art will recognize, when routing the bus 16, normal wiring considerations should be made to bypass the cabinetry and/or the wall.

FIG. 2 shows the control information system 14 in further detail in one embodiment. The control information system 14 includes a touch-sensitive switch area 30 and a status indicator area 40. The switch area 30 includes various switches for controlling the operation of the disposer 10. For example, in this embodiment, switch area includes three switches 41, 42, and 43 for operating the disposer at respectively lower speed. Because the user may not particularly care what speed is chosen, but is more concerned with adequately grinding food waste of a particular constituency, these switches 41-43 are conveniently labeled as “soft,” “hard,” and “mix.” Of course, these switches could be alternatively labeled with motor speed (e.g., fast or slow, or with the actual motor rpm speed), but such technically-accurate information may not be as helpful to a lay user of the disposer 10.

The status indicator area 40 provides the user information concerning the status of the disposer 10. For example, and as shown, the status indicator area 40 includes light, specifically light emitting diodes (LEDs) 45-48, which indicate that the disposer has been turned on (LED 45), that water is running within the unit (LED 46), that the unit has stalled because of a jam (LED 48), and that metal (e.g., an eating implement) has been detected in the disposer (LED 47). A circuit controller controls the operation of the LEDs 45-48, and receives input from the switches 41-43.

In addition to, or in place of, the LED 45 that indicates whether the disposer is on, the control information system 14 includes an audio output device such as a speaker 49 to provide an audible indication that the disposer is running. For example, the “Audio On Indicator” provides a pre-programmed audio message, sound or music, via the speaker 49 when the disposer is turned on. The person using the disposer can choose his favorite song, sounds, or spoken message. A volume control 44 allows setting the volume of the audio indicator at the desired level.

In one embodiment, the control information system 14 is comprised of two parts: an electrical box 50 and an electrical box cover 51. Both of these components are preferably of a standard size used in household electrical outlets, with the electrical box 50 measuring 1.75×2.75 inches and the electrical box cover 51 measuring 2.75×4.5 inches. Of course, other sizes for these components could be used.

The switches 41-43 and volume control 44 could comprise many different type of actuating switches, including regular light switches, or spring action buttons, but are preferably touch sensitive bubble switches which are common in the appliance industry. Likewise, other types of indicators (conventional filament lights, gauges, etc.) could be used in lieu of LEDs 45-48. Or, the status indicator area 40 could comprise a textual readout, for example, a liquid crystal display or dot matrix display which would spell out the status (“running,” “idle,” “jammed,” “high speed,” etc.). In this embodiment, the display could include several lines or areas to allow multiple statuses to be displayed if necessary (e.g., “jammed” and “metal in unit”). Other non-visual indicators could be used in addition to the “on indicator,” such as audible alarms which broadcast different noises or tones through the speaker 49. The speaker 49 can further broadcast the status by playing a recorded voice, which would “speak” the relevant status.

In a preferred embodiment, the electrical box 50 contains a single uniform layer of a plastic laminate over both the switches 41-44 and the LEDs 45-48, as is common in the appliance industry. This construction allows the function for the switches and a description of the status indicators to be written onto the laminate layer, while also protecting the switches and indicators from damage and moisture. As the laminate layer is basically flat, it is easily cleaned by with a damp cloth.

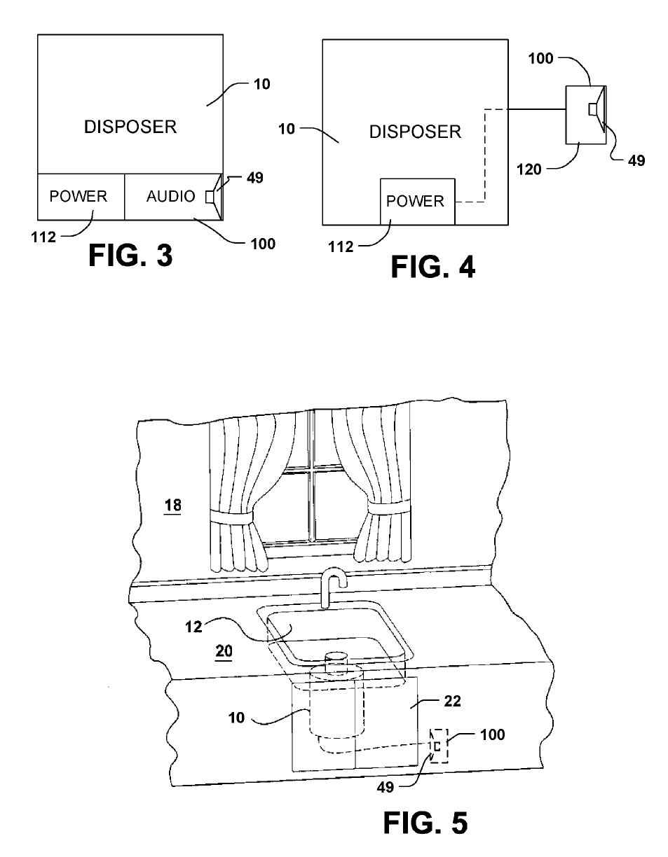

In some disposer installations, it is difficult or impractical to install the entire control information system 14. However, an indicator to notify a user that the disposer has been actuated may still be required. FIG. 3 is a block diagram conceptually illustrating an alternative embodiment of an audio indicator 100. In the illustrated embodiment, the indicator 100 is situated within the housing of the disposer 10 and is wired into the disposer's power supply 112. Alternatively, the indicator 100 may be powered by a separate power supply. The indicator 100 includes power circuitry, if necessary, to adjust the received power as necessary to power an audio circuit and speaker 49. The disposer 10 includes openings in its housing for the speaker 49 output and for access to the indicator 100 for programming the device.

In FIG. 4, another embodiment is shown in which the indicator 100 is situated in a separate enclosure 120. The speaker 49 and audio circuitry are situated inside the enclosure 120. The indicator 100 may receive power from the disposer 10 as shown in FIG. 4, or a separate power supply could be used. The enclosure 120 can be installed in a convenient location, such as next to the disposer power switch in the wall or counter adjacent to the sink. Alternatively, to prevent the labor of cutting openings in the wall or counter and associated finish work, the enclosure 120 can be mounted inside the cabinet containing the disposer as shown in FIG. 5. Locating the enclosure 120 near a cabinet door 22 allows people to hear the sounds emitting from the speaker 49.

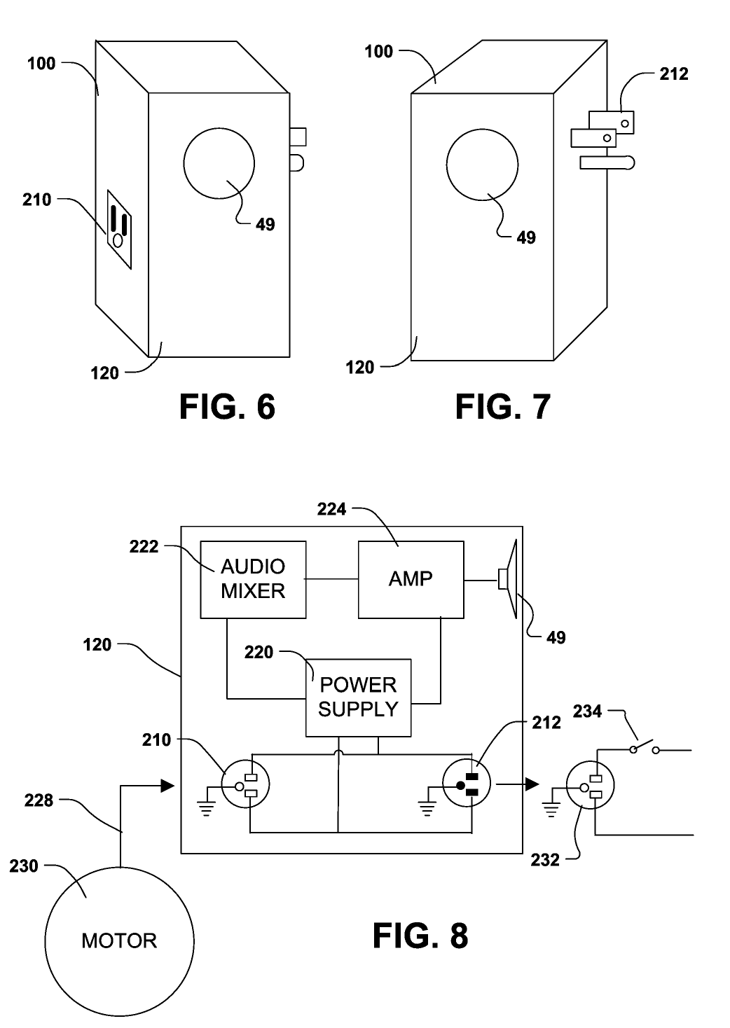

FIGS. 6 and 7 show perspective views of an audio indicator 100 that can be easily added to an installed disposer system. The audio indicator includes an enclosure 120 that has a standard AC outlet 210 on one side, and a standard electrical plug 212 on the opposite side. As shown in FIG. 8, the enclosure 120 further contains a power supply 220 connected to the outlet 210 and plug 212. An audio mixer 222 and amplifier 224 provide an output to the speaker 49 and receive power from the power supply 220.

Rather than plugging the power cord 228 for the disposer's motor 230 directly into a switched outlet as in standard installations, the power cord 228 plugs into the outlet 210 of the audio indicator 100, and the plug 212 is received by a switched outlet 232 that is connected to standard household power via a wall switch 234. When the switch is closed to activate the disposer motor 230, the indicator 100 is also activated to produce the audio indicator through the speaker 49.

The indicator 100 can be programmed to play a variety of sounds to provide an indication that the disposer is on, such as a pre-programmed voice message, sound or music. As noted herein, disposers without technology to reduce noise do not need a separate indicator because it is immediately evident that the disposer is operating from the noise it generates. Further, the generated noise is not particularly pleasant to most disposer users. The audio indicator 100 disclosed herein can make food preparation tasks and clean-up more pleasant for the consumer or cook by allowing them to hear pleasant sounds or their favorite music when the disposer is operating.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A food waste disposer system, comprising:
a food waste disposer;
an audio indicator operably connected to the food waste disposer, the audio indicator outputting a predetermined sound in response to activating the disposer.

2. The food waste disposer system of claim 1, wherein the audio indicator includes a speaker.

3. The food waste disposer system of claim 2, wherein the audio indicator includes an audio mixer having an output connected to an input of an amplifier, and the amplifier has an output connected to the speaker.

4. The food waste disposer system of claim 1, wherein the audio indicator is situated within an enclosure housing the food waste disposer.

5. The food waste disposer system of claim 4, wherein the enclosure defines an opening to allow access to the audio indicator.

6. The food waste disposer system of claim 4, wherein a speaker is situated in the enclosure.

7. The food waste disposer system of claim 1, wherein the audio indicator is situated within an enclosure positioned remotely from the food waste disposer.

8. The food waste disposer system of claim 1, wherein the food waste disposer includes a power supply, and wherein the audio indicator is powered via the food waste disposer power supply.

9. The food waste disposer system of claim 7, wherein the enclosure further houses switches for operating the food waste disposer.

10. The food waste disposer system of claim 7, wherein the enclosure includes a speaker housed therein.

11. The food waste disposer system of claim 7, wherein the enclosure includes an electrical outlet receiving an electrical plug of the food waste disposer, and wherein the enclosure includes an electrical plug that is receivable by a household electrical outlet.

12. The food waste disposer system of claim 1, wherein the predetermined sound is music.

13. The food waste disposer system of claim 1, wherein the predetermined sound is a recorded voice.

14. An audio system for indicating the operational status of a food waste disposer, comprising:
an enclosure;
a speaker situated in the enclosure;
an audio circuit connectable to a food waste disposer, the audio circuit providing an output to the speaker in response to turning on the disposer.

15. The system of claim 14, wherein the audio circuit includes an audio mixer connected to an amplifier.

16. The system of claim 14, further comprising a power supply situated in the enclosure, the power supply being connectable to a household electrical outlet.

17. The system of claim 16, further comprising an electrical outlet connected to the power supply for receiving a power plug of the food waste disposer.

18. A method of operating a food waste disposer, comprising:
activating the disposer; and
activating an audio circuit to play a predetermined sound in response to the activation of the disposer.

19. The method of claim 18, wherein the predetermined sound includes at least one of a predetermined voice message or music.

20. The method of claim 18, further comprising situating the audio circuit in an enclosure.

21. The method of claim 20, further comprising situating the enclosure remotely from the food waste disposer.

22. The method of claim 20, further comprising plugging a power cord of the disposer into an outlet in the enclosure, and plugging a power plug connected to the enclosure into a household power outlet.
